(19) United States
(12) Patent Application Publication
(10) Pub. No.: US 2012/0116837 A1
(43) Pub. Date: May 10, 2012

(54) SOCIAL RISK MANAGEMENT SYSTEM AND METHOD

(75) Inventors: Johana DUNLOP, Paris (FR); Oscar Mauricio Villegas Bello, Lyon (FR)

(73) Assignee: SCHLUMBERGER TECHNOLOGY CORPORATION, Houston, TX (US)

(21) Appl. No.: 12/939,391

(22) Filed: Nov. 4, 2010

(51) Int. Cl. G06Q 10/00

(52) U.S. Cl. 705/7.28

(57) ABSTRACT

The present invention provides a social risk management system and method capable of analyzing data pertaining to an economic venture, identifying social risks that may be encountered, generating specific prevention and mitigation measures for those hazards, and evaluating the results. In one embodiment, the present invention provides a user-friendly graphic user interface through which users may access the unique functionality of the present invention. In one embodiment, the present invention is capable of utilizing feedback data to generate one or more evaluation reports illustrating the success, or lack thereof, of the implemented prevention/mitigation measures.

### FIELD OF THE INVENTION

The present invention relates generally to risk management and, more particularly, to social risk management systems and methods.

### BACKGROUND OF THE INVENTION

Large economic ventures, such as infrastructure, transportation, and oil and gas projects can have a profound impact on nearby communities. Social risks ranging from noise pollution to social unrest can be caused by and/or exacerbated by such projects. Social risk can lead to work stoppages, delays and other events detrimental to the project and the organization(s) involved. There remains a need for a system and method capable of facilitating the management of social risk in an efficient and effective manner.

### SUMMARY OF THE INVENTION

Accordingly, the present invention provides a social risk management system and method capable of analyzing data pertaining to an economic venture, identifying social risks that may be encountered, generating specific prevention and mitigation measures for those hazards, and evaluating the results. In one embodiment, background data pertaining to an economic venture may be divided into categories and subcategories in order to simplify data entry into the system as well as subsequent analysis of the data. In one embodiment, the present invention utilizes community, project, client, and stakeholder data in order to identify social hazards applicable to the economic venture. In one embodiment, the present invention provides a user-friendly graphic user interface through which users may access the unique functionality of the present invention.

In one embodiment, community data utilized by the present invention relates to the community where the economic venture is to be conducted. In one embodiment, project data describes the operational footprint and, when analyzed in conjunction with community information, provides guidance as to the nature of the economic venture's impact on local communities. Further, in one embodiment, project information provides an inventory of contractual requirements along with information regarding the responsibilities of each party in connection with the economic venture. In one embodiment, client data provides an understanding of the client's interest in social risk management and related mitigation measures. In one embodiment, stakeholder data provides information regarding individuals and/or groups that can influence or be influenced by the venture as well as an assessment of the relevance and influence of each stakeholder with respect to the venture.

In one embodiment, background data may be analyzed in order to identify social hazards that may be encountered in connection with the venture. In one embodiment, the analysis of background data includes a review of all community, project, client, and stakeholder data collected with respect to the venture. The analysis may include the identification and cross-referencing of related background data across multiple categories and/or subcategories in order to provide a complete picture of the social risk landscape.

In one embodiment, after identifying the social hazards that may be encountered, the present invention conducts a risk assessment of each identified social hazard and displays the results. In one embodiment, this entails a determination of the severity and likelihood of each identified hazard using background information available to the system.

In one embodiment, the present invention generates a risk assessment for each identified social hazard and displays the results to the user. In one embodiment, the present invention identifies and displays one or more prevention and/or mitigation measures designed to address each identified social hazard. In one embodiment, prevention measures are intended to reduce the likelihood that an issue will occur, and mitigation measures are intended to reduce the impact of social hazards on the project.

In one embodiment, the present invention provides an updated risk assessment feature that assumes the successful implementation of the identified prevention/mitigation measures. This allows the user to review the updated risk assessment (also referred to herein as the residual risk) and prospectively consider whether any other measures should be taken. In one embodiment, the present invention may also conduct a feasibility review of the identified prevention/mitigation measures.

In one embodiment, the present invention utilizes information available to the system, including background data, user input and user comments, to generate a social risk management outline providing an overview of how each identified social risk is to be handled for the economic venture. In one embodiment, the social risk management outline may also include a ramp down strategy for each proposed activity. The ramp down strategy may include guidance and/or suggestions regarding the closure and handover of social risk management efforts in the community.

In one embodiment, the present invention generates an execution plan providing, among other things, milestones, objectives, budgets, and schedules related to the implementation of each prevention/mitigation measure. In one embodiment, the present invention may also address how decisions are made and approved with respect to the social risk management process. In one embodiment, the present invention is capable of providing recommendations and/or designations with respect to whom (both inside and outside the organization) should be tasked with overseeing and providing management guidance for the social risk management processes described herein.

In one embodiment, the present invention receives and stores feedback data including evidence pertaining to the results generated by the measure(s), applicable key performance indicators, and/or lessons learned. In one embodiment, the present invention utilizes feedback data to generate one or more evaluation reports illustrating the success, or lack thereof, of the implemented prevention/mitigation measures. Such reports may be used to update and/or improve the social risk management process.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings; it being understood that the drawings contained herein are not necessarily drawn to scale; wherein:

FIGS. 1, 2, 3, 4, 5 and 6 are flowchart diagrams illustrating the social risk management process of one embodiment of the present invention.

FIGS. 2A-2I, 4A-4E, 5A, and 6A-6B are example graphic user interfaces that may be used in conjunction with one or more embodiments of the present invention.

FIG. 7 is a component diagram illustrating an example computer system that may be utilized in conjunction with one embodiment of the present invention.

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described example embodiments may be possible.

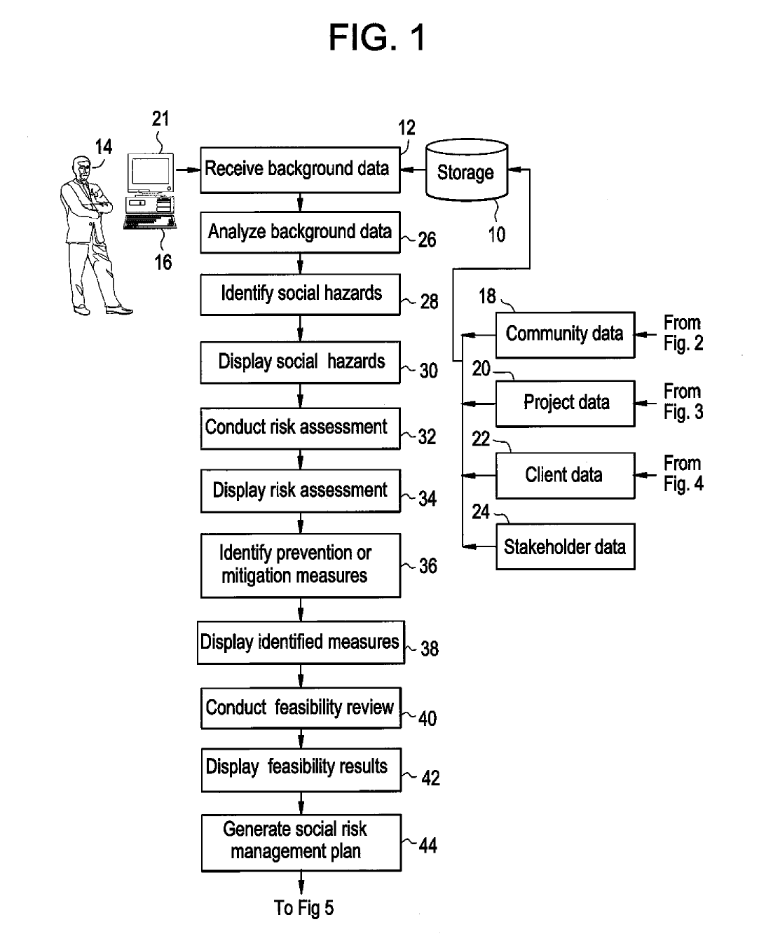

The present invention is herein described as a computer implemented method of facilitating social risk management, as a computer-readable storage medium for facilitating social risk management and as a social risk management system. Referring to FIG. 1, the present invention utilizes one or more computer databases (10). The computer database (10) of the present invention may be any suitable storage device, whether part of a stand alone storage device or as part of a larger computer system. The database of the present invention may be accessed and/or updated via one or more computer networks.

In one embodiment, background data pertaining to an economic venture may be collected and stored upon the database, as illustrated by Box (12). Data may be manually entered into the system by the user (14), downloaded using any suitable downloading technique and/or transferred/copied from another storage device. The database (10) of the present invention may be accessed by the user (14) using one or more graphic user interfaces (21). The graphic user interface of the present invention may be provided on a computer (16) and may be accessible via one or more computer networks.

Background data relating to the economic venture may be gleaned from any number of sources, including but not limited to, data obtained during other social risk management operations, data obtained by personnel currently involved with the venture, and/or government data. In one embodiment, background data pertaining to an economic venture may be divided into categories and subcategories in order to simplify data entry into the system as well as subsequent analysis of the data.

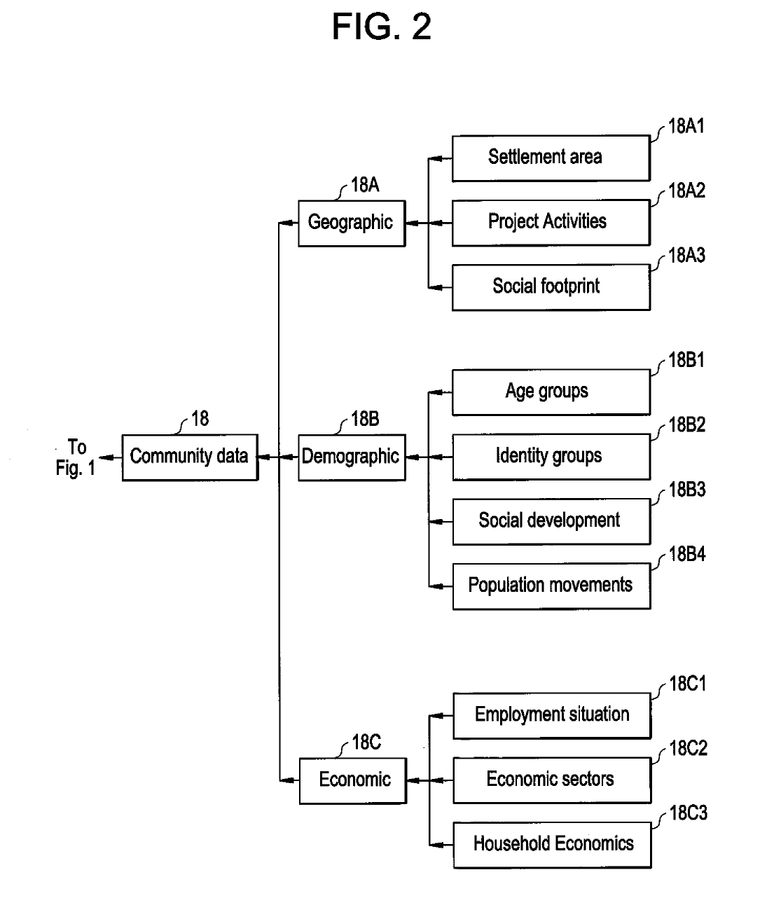

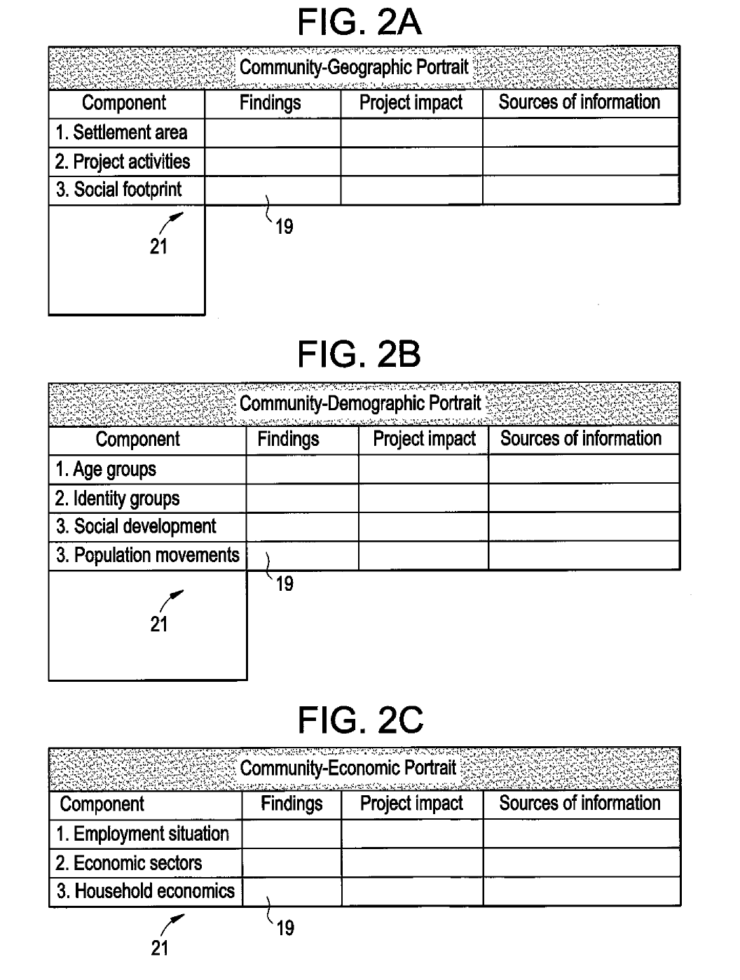

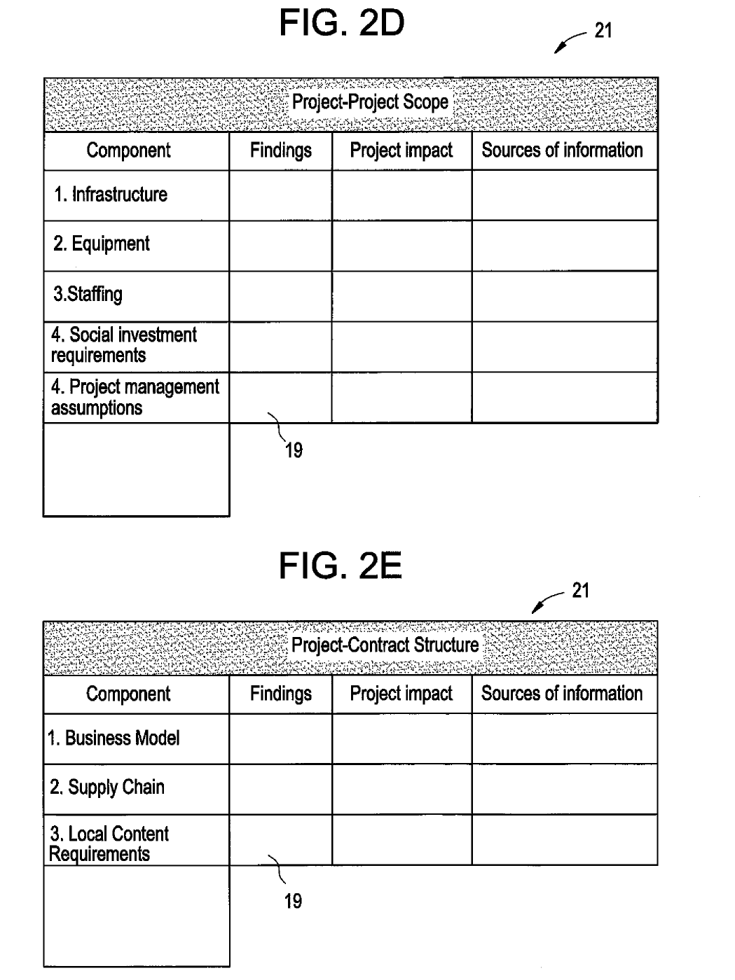

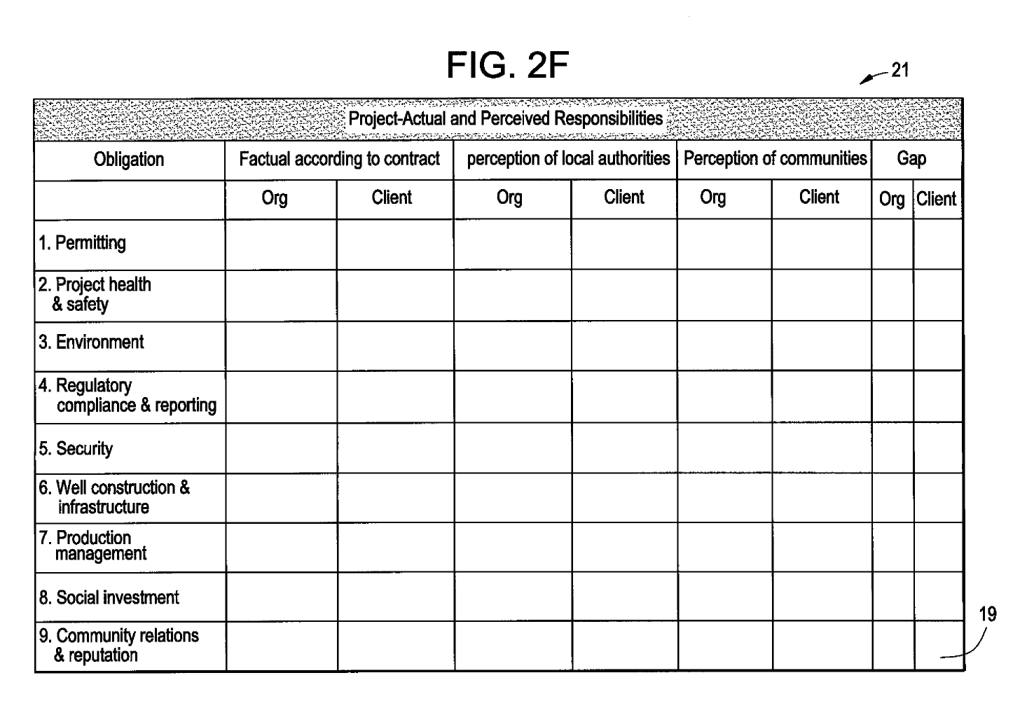

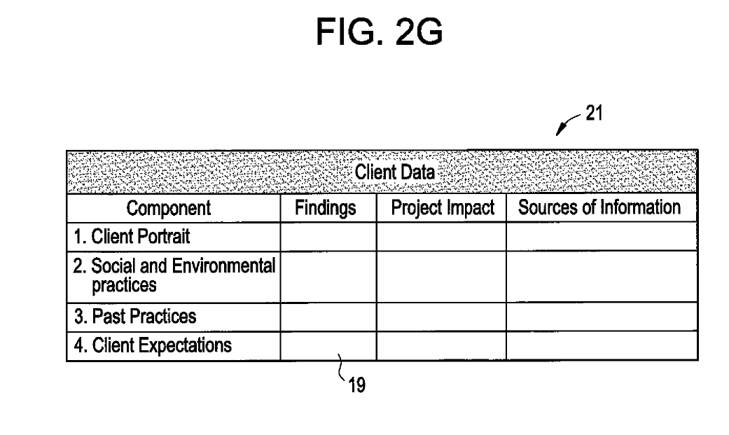

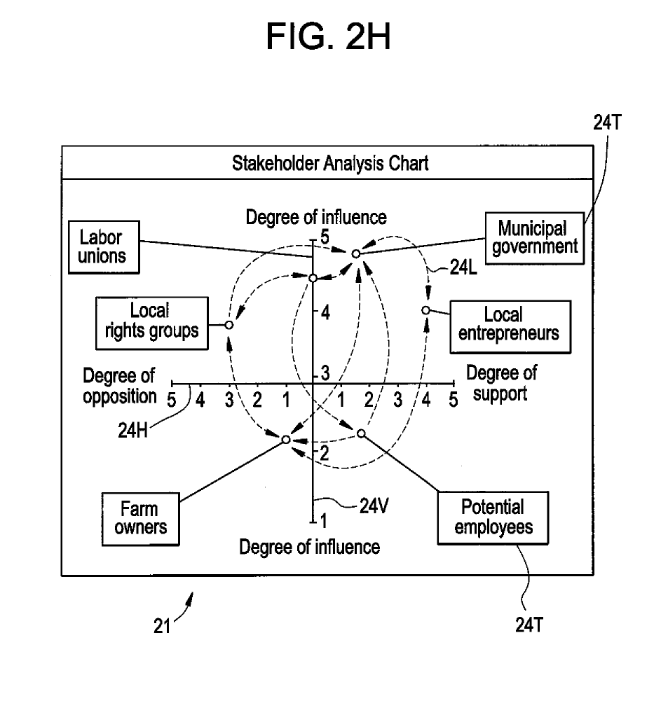

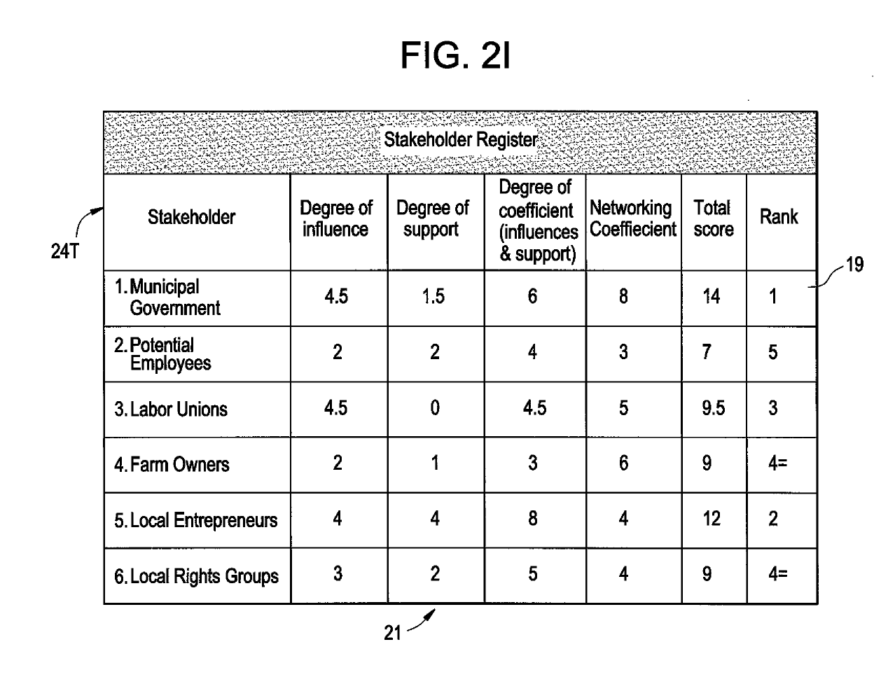

In one embodiment, background data utilized by the present invention may be divided into community, project, client, and stakeholder data categories (18, 20, 22, and 24, respectively). In one embodiment, community data utilized by the present invention describes the community where the economic venture is to be conducted. In one embodiment, each background data category may be further divided into subcategories or portraits. For example, referring to FIG. 2, data concerning the community (18) may be divided into geographic (18A), demographic (18B), and economic portraits (18C) of the community. Taken together, these portraits provide an overview of the social elements in the relevant community that can influence or be influenced by the economic venture.

In one embodiment, a geographic portrait (18A) may be used to define the project boundaries and to identify human activities within the area affected by the venture. In one embodiment, there are three information subcategories for the geographic portrait of the community. The first subcategory in this example, settlement area (18A1), may be used to provide data describing the boundaries of the area to be investigated and identifying the local infrastructure.

In one embodiment, the settlement area subcategory also provides information relating to the geographic context (offshore, jungle, highly populated, desert, etc) of the venture. For example, a map of the area may be used to identify all human settlements including habitats, farming areas, animal breeding areas, industries, local markets, water sources, health care providers including hospitals, education providers, government offices, airports, roads, religious and symbolic places such as cemeteries, churches, mosques and/or places of worship.

The second subcategory within the geographic information category in this example, project activities (18A2), may be used to identify where activities relating to the economic venture are conducted. In the context of an oilfield economic venture, the project activities subcategory (18A2) may include information such as the location of existing oilfields, area(s) contemplated for well drilling, the location of base operations, client office(s) and/or satellite bases.

The third subcategory within the geographic information category in this example, social footprint (18A3), may be used to identify populations in the community that may have an interaction with or be affected by the venture. In one embodiment, the social footprint subcategory may include information such as populations which are likely to benefit directly from the venture (from employment, for example) as well as populations that indirectly benefit from the venture (for example, merchants, restaurants, welding companies, etc). Neighboring populations may also be included along with population(s) that may suffer negative consequences due to physical proximity to venture activities, whether from things such as vibration, impaired views, noise, dust, pollution and/or road safety issues. Information in the social footprint subcategory (18A3) may also include information regarding groups that may come in contact with key project components in order to anticipate how they will come into contact, and how they might react to such contact.

Referring to FIG. 2A, in one embodiment, the present invention provides one or more graphic user interfaces (21) to facilitate entry and analysis of community data. In this example, the present invention provides data entry fields and/or drop down menus (19) for each aspect of the geographic portrait subcategory, i.e., settlement area, project activities, and social footprint information in this example. In one embodiment, the community data GUI of the present invention provides data entry fields and/or drop down menus for findings, project impact, and source information relating to each geographic portrait subcategory.

Referring back to FIG. 2, in one embodiment, a demographic portrait subcategory (18B) may be used to develop an understanding of the diversity and composition of populations within the project area. In one embodiment, this is accomplished by identifying key age groups and key identity groups within the community, assessing social development including local population growth or decline in the community, and identifying major population movements.

In one embodiment, the present invention utilizes four information subcategories for the demographic portrait (18B) of the community. The first subcategory in this example, age groups (18B1), may be used to identify the main age groups in the community using census or other available data. Gender information may also be included in the age groups subcategory.

The second subcategory within the demographic information category in this example, identity groups (18B2), may be used to identify important religious, ethnic and/or tribal groups in the community. This feature of the present invention is particularly helpful when one or more groups in the community have an important role and/or relationship to the venture.

The third subcategory within the demographic information category in this example, social development (18B3), may be used to identify social development issues such as the access to education and health care in the community as well as mortality and fertility rates. Generally used social footprint indicators provided by social development agencies or other authorities may be used in this example. The fourth subcategory within the demographic information category in this example, population movements (18B4), may be used to identify trends in the movement and composition of the local population, including long-term migration trends.

Referring to FIG. 2B, in one embodiment, the present invention provides one or more graphic user interfaces (21) to facilitate the entry and analysis of community data. In this example, the present invention provides data entry fields and/or drop down menus (19) for each aspect of the demographic portrait subcategory, i.e., age groups, identity groups, social development, and population movement information. In one embodiment, the GUI of the present invention provides data entry fields and/or drop down menus for findings, project impact, and source information relating to each demographic portrait subcategory.

Referring back to FIG. 2, in one embodiment, an economic portrait subcategory (18C) may be used to gather information regarding the size and scope of the economic venture relative to other forms of economic activity in the community. In one embodiment, the present invention utilizes three information subcategories for the economic portrait of the community intended to capture employment patterns, key economic sectors and provide information regarding households within the project area.

The first subcategory in this example, employment situation (18C1), may be used to provide information regarding the local employment situation including employment and unemployment rates for each group identified in the demographic portrait as well as the recruitment potential of members of the community. The second subcategory within the economic information category in this example, economic sectors (18C2), may be used to identify key economic sectors such as agriculture, extraction, local industries and services, and to evaluate their influence on the local economy. In one embodiment, information provided by the economic sectors subcategory may be helpful in understanding the relative importance of each economic sector in the community.

The third subcategory within the economic information category in this example, household economics (18C3), may be used to map household economic activities in the community by identifying key sources of revenue in cash and in goods (employment, remittances, agriculture, loans, etc), and by providing information regarding the relative weight of each revenue source within household income. In one embodiment, census and other governmental data may be used to identify key expenditures such as food, health, education and repayment of debt, and to establish the relative weight of each type of expenditure within the household.

Referring to FIG. 2C, in one embodiment, the present invention provides one or more graphic user interfaces (21) to facilitate entry of economic data into the system. In this example, the present invention provides data entry fields and/or drop down menus (19) for each aspect of the economic portrait subcategory, i.e., employment situation, economic sectors, and household economics information. In one embodiment, the GUI of the present invention provides data entry fields and/or drop down menus for findings, project impact, and source information relating to each economic portrait subcategory.

As noted above, background data utilized by the present invention may be broken down into community, project, client, and stakeholder data categories (18, 20, 22, and 24, respectively). In one embodiment, project data utilized by the present invention describes the operational footprint and, when analyzed in conjunction with community information, provides guidance as to the nature of the economic venture's impact on local communities. Further, in one embodiment, project information provides an inventory of contractual requirements along with information regarding the responsibilities of each party in connection with the economic venture.

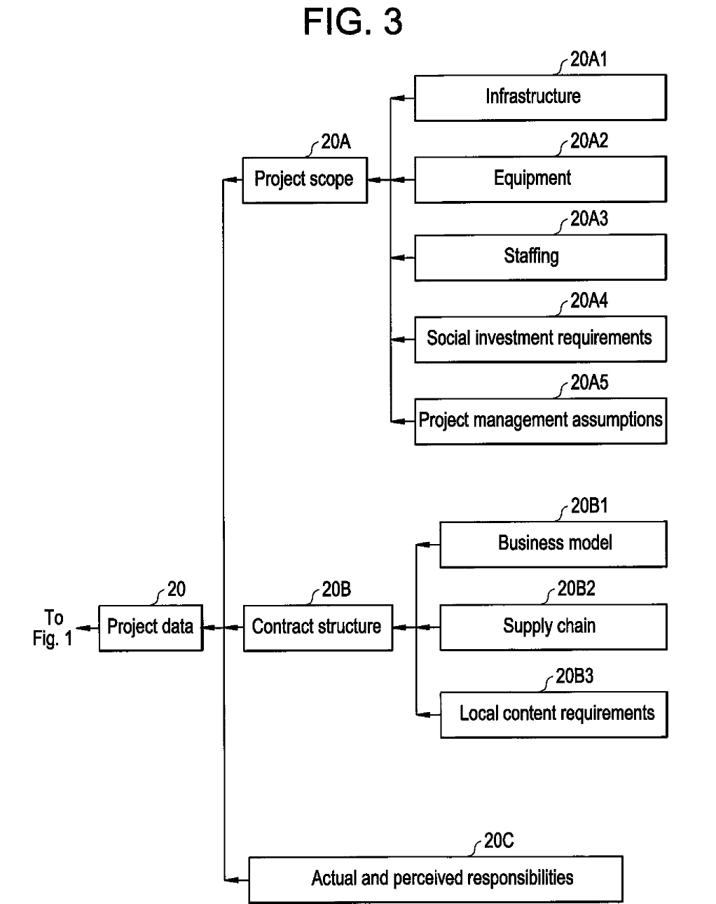

Referring to FIG. 3, data concerning the project at issue may be divided into project scope (20A), contract structure (20B), and actual and perceived responsibilities (20C) information. Taken together, these portraits provide an overview of the operational footprint of the economic venture.

In one embodiment, a project scope subcategory (20A) may be used to identify and describe any unique characteristics of the project. In one embodiment, there are five information subcategories for the project scope portrait of the community. The first subcategory in this example, infrastructure (20A1), may be used to describe the type of infrastructure required by the project. Information such as roads, platforms, facilities, pipelines, buildings and other facilities required by the project may be included in the infrastructure subcategory. Further, information regarding the magnitude and the duration of the effort required to build needed infrastructure, including information such as the number of employees needed, the required qualifications for each employee, the type and number of equipment and transport units required, the work schedules, etc., may be included in the infrastructure subcategory.

The second subcategory within the project scope category in this example, equipment (20A2), may be used to describe the required equipment to execute the economic venture. In the context of an oilfield economic venture, the equipment subcategory (20A2) may include information such as the type of drilling equipment required to run the project, such as the number of rigs, vehicles, boats, etc.

The third subcategory within the project scope category in this example, staffing (20A3), may be used to describe the human resources that are expected to be deployed over the different stages of the project. This may include a listing of the number of people in each staffing category (expatriates, nationals and locals, for example) and the skills required (management, engineers, technical, operational, labor, etc). This type of information is important as access to jobs is a common expectation within surrounding communities when a large economic venture is deployed. The staffing subcategory may also include information regarding the extent to which communities can meet project staffing needs.

The fourth subcategory within the project scope portrait in this example, social investment requirements (20A4), may be used to describe the social investment requirements (if any) expressed in the call for tender or other applicable legal documents relating to the venture. Such information may include the amount, the type of activity, the duration of each activity and the implementation methodology, i.e., direct implementation or through local organizations, clients, etc.

The fifth subcategory within the project scope portrait in this example, project management assumptions (20A5), may be used to describe the project's objectives, authorities in charge of the project, duration and phases of the project, budget (with details on amount and timing) and partners (including a history of the partner's community relations and operating practice).

Referring to FIG. 2D, in one embodiment, the present invention provides one or more graphic user interfaces (21) to facilitate entry of project scope data into the system. In this example, the present invention provides data entry fields and/or drop down menus (19) for each aspect of the project scope subcategory, i.e., infrastructure, equipment, staffing, social investment requirements, and project management assumptions in this example. In one embodiment, the project scope GUI of the present invention provides data entry fields and/or drop down menus for findings, project impact, and source information relating to each project scope subcategory.

In one embodiment, a contract structure portrait (20B) may be used to take into account the type of contract involved with the venture, the financial exposure for the parties involved, and which party makes decisions as they pertain to the venture. In one embodiment, there are three information subcategories for the contract structure portrait of the community. The first subcategory in this example, business model (20B1), may be used to describe the type of contract used in conjunction with the venture, e.g., lump sum, fee plus incentive, or fee contract. For example, in an arrangement where an organization is working on an economic venture with a client, a lump-sum contract may place greater social risk exposure upon the organization while a fee-for-service deal may place more exposure on the client.

The second subcategory within the contract structure portrait in this example, supply chain (20B2), may be used to identify supply chain elements including products and services to be sourced. Provision of goods and services is a common expectation within surrounding communities. In one embodiment, it may be important to consider the extent to which communities can meet the supply chain needs of the venture. The supply chain subcategory may also be used to facilitate the preliminary analysis of the potential for sourcing products and services locally.

The third subcategory within the contract structure portrait in this example, local content requirements (20B3), may be used to describe commitments and/or requirements of the local community in terms of people and supply chain needs. Local content requirements information may also include information regarding government requirements to use local or national workers and/or particular suppliers for the venture.

Referring to FIG. 2E, in one embodiment, the present invention provides one or more graphic user interfaces (21) to facilitate entry of contract structure data into the system. In this example, the present invention provides data entry fields and/or drop down menus (19) for each aspect of the contract structure subcategory, i.e., business model, supply chain, and local content requirements. In one embodiment, the GUI of the present invention provides data entry fields and/or drop down menus for findings, project impact, and source information relating to each contract structure subcategory.

In one embodiment, an actual and perceived responsibilities subcategory (20C) may be used to describe the perceptions that exist among various stakeholders with respect to the economic venture. In some cases, expectations among various stakeholders in an economic venture may differ from the terms spelled out in the contract. Thus, information relating to both the contract and the expectations of the parties may be helpful in order to assure that the proper party is involved in the social risk management process.

Referring to FIG. 2F, in one embodiment, the present invention provides one or more graphic user interfaces (21) to facilitate entry of actual and perceived responsibilities information into the system. In this example, the present invention provides data entry fields and/or drop down menus (19) for various aspects of the actual and perceived responsibilities subcategory, i.e., permitting, project health and safety, environment, regulatory compliance and reporting, security, well construction and infrastructure, production management, social investment, and community relations and reputation. Data concerning the contract itself, the perception of local authorities, the perceptions of local communities and perceived or actual gaps in responsibility may also be provided.

In one embodiment, the GUI (21) of the present invention provides data entry fields and/or drop down menus for capturing information relating to how each stakeholder perceives the venture, i.e., who is responsible and accountable for which aspect of the social risk management of the project as well as whether there are gaps in perceived or actual responsibility for a given aspect of the venture. In one embodiment, the present invention allows the user to make distinctions between responsibility, i.e., the party executing the work, and accountability, i.e., the party ultimately responsible for the work, for each aspect of the venture. This may be accomplished using any suitable data entry or data amendment convention. In one embodiment, the user may enter/select an “A” to indicate a party is accountable or enter/select an “R” to indicate a party is responsible for a given aspect of the venture.

As noted above, background data utilized by the present invention may be divided into community, project, client, and stakeholder data categories (18, 20, 22, and 24, respectively). In one embodiment, client data utilized by the present invention provides an understanding of the client's interest in social risk management and related mitigation measures. National or international oil companies may view social risk management differently from, for example, small independent companies. Receiving and analyzing data pertaining to the client's characteristics, expectations and past involvement in social risk management, allows the system and the user to better address potential social risk. In one embodiment, there may be multiple clients involved with the venture, each having different experiences, capabilities, and expectations when it comes to social risk.

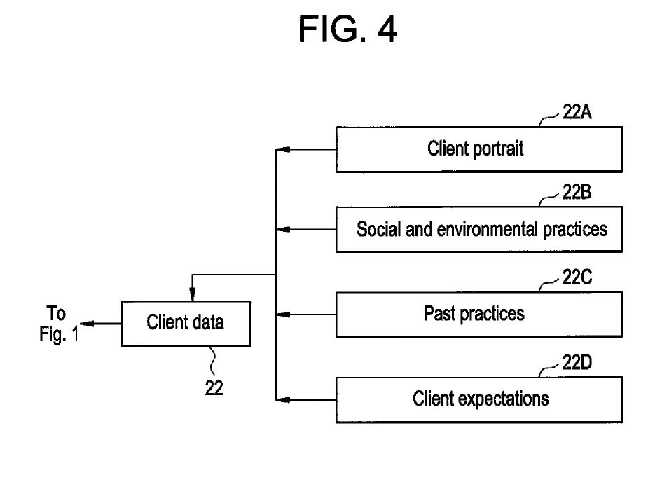

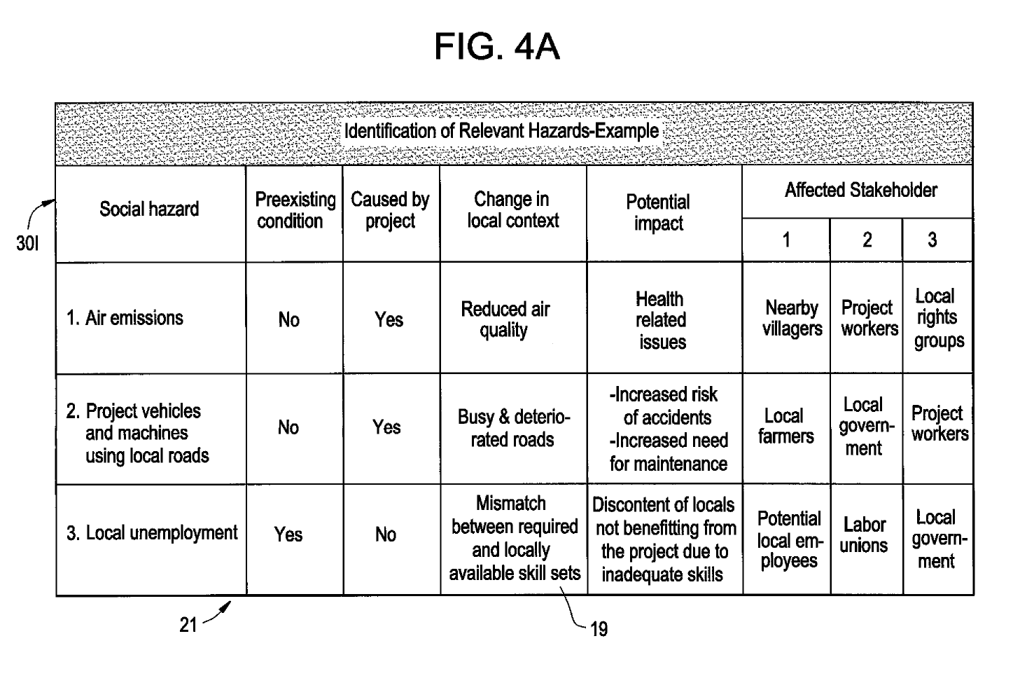

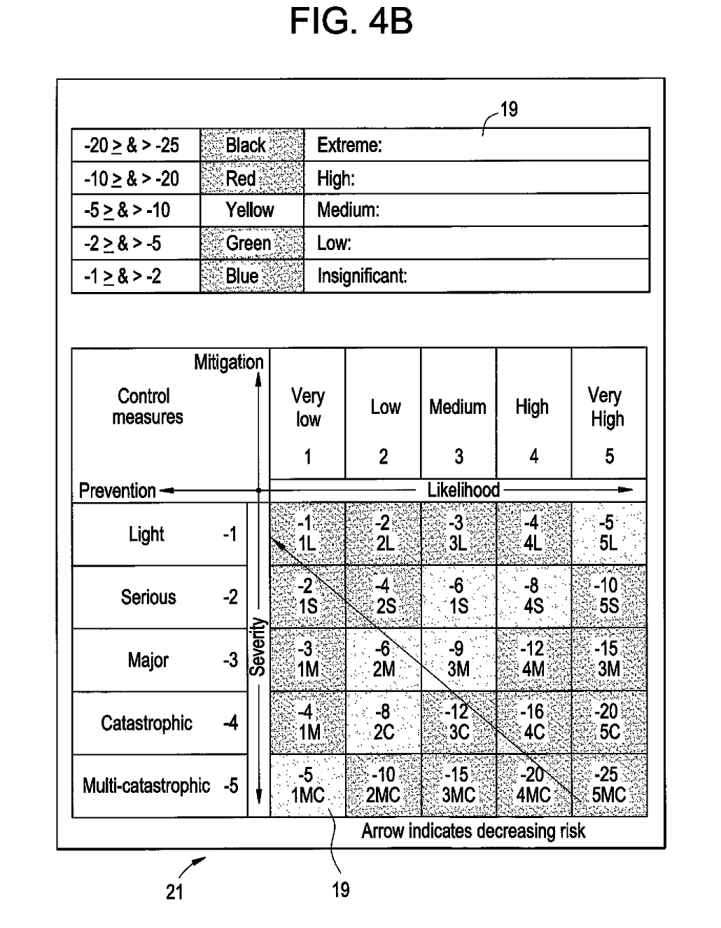

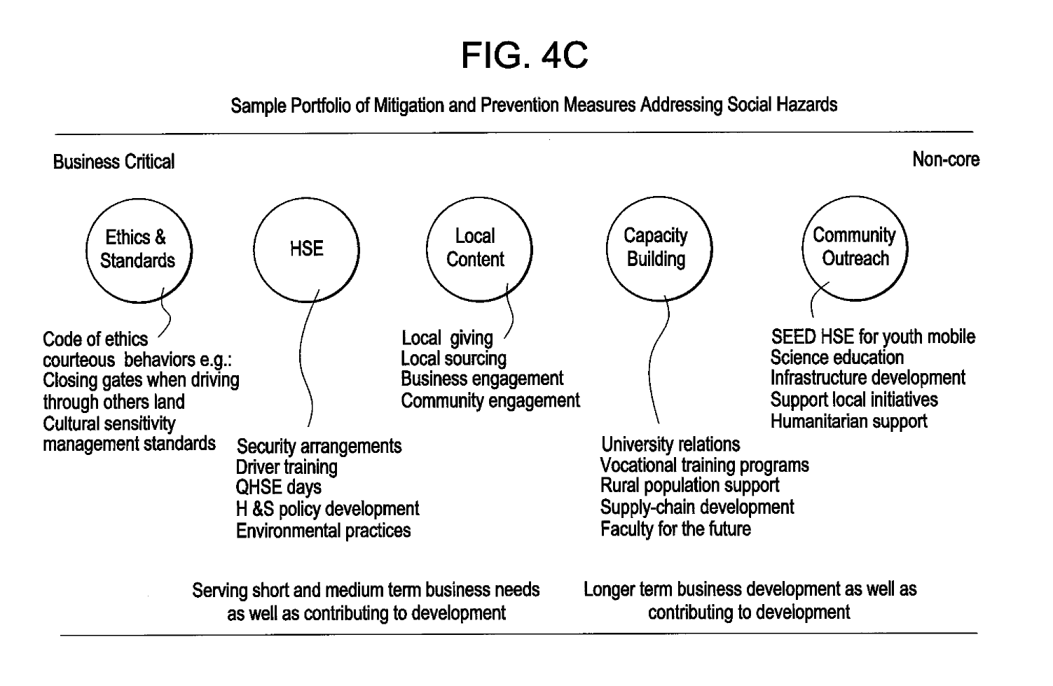

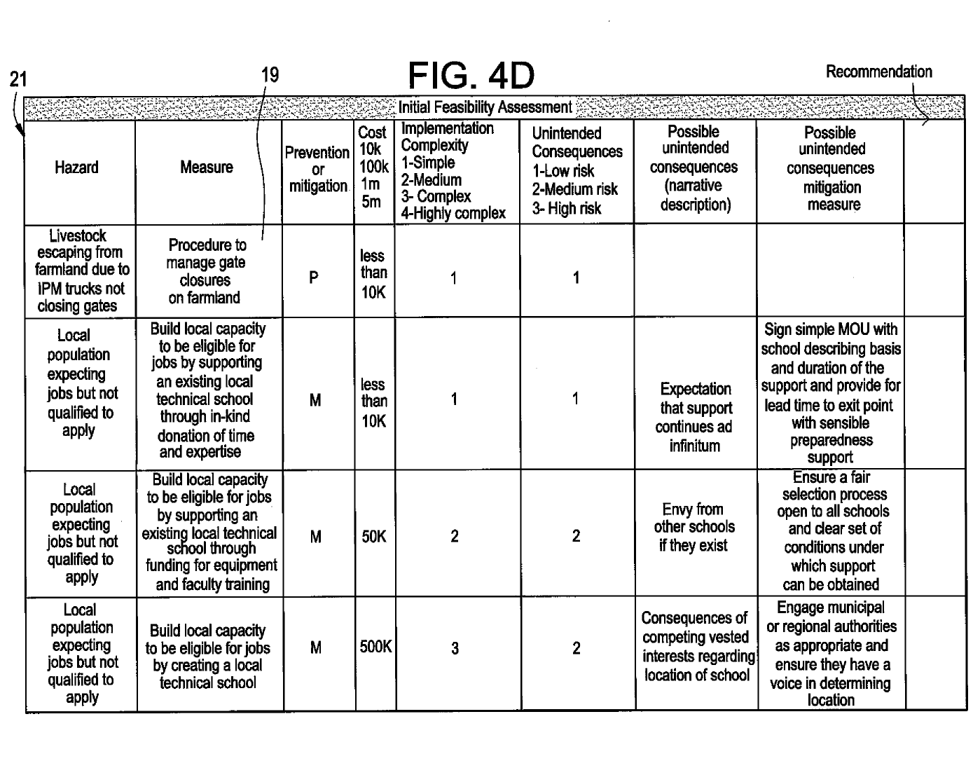

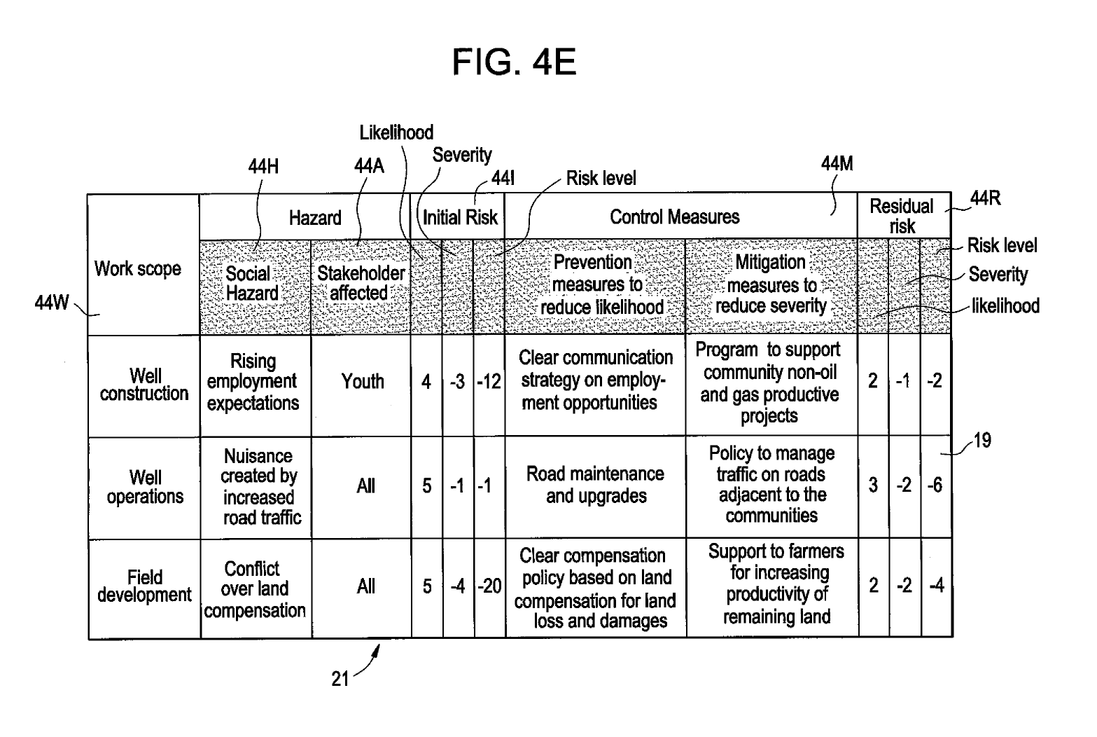

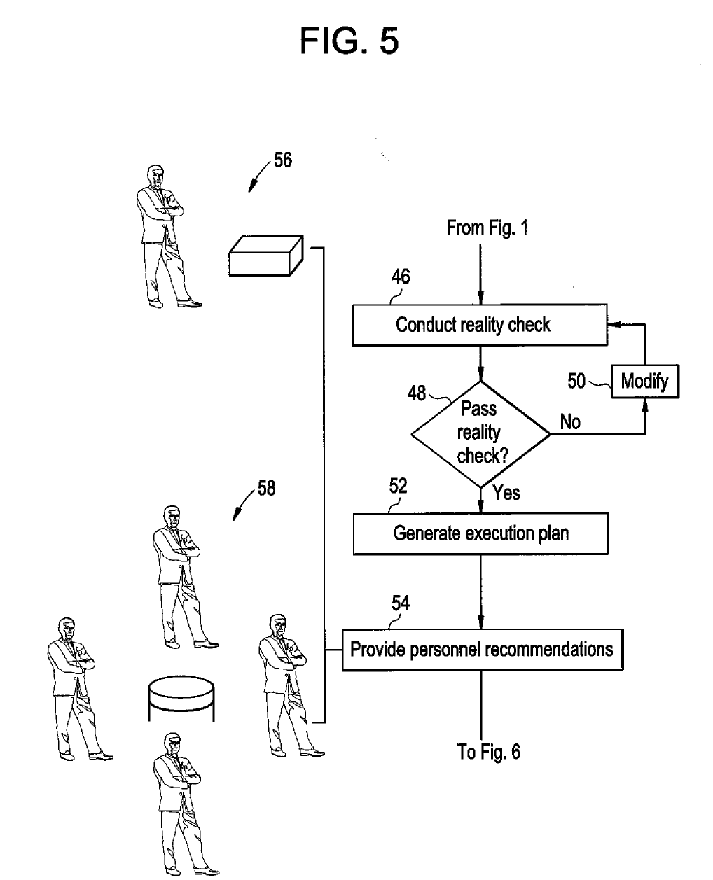

Referring to FIG. 4, data concerning clients involved in the venture may be divided into client portraits (22A), social and environmental practices (22B), past practices (22C), and client expectations (22D). Taken together, these portraits provide an understanding of the client's viewpoint of the venture from a social risk standpoint.

In one embodiment, a client portrait subcategory (22A) may be used to identify the characteristics of the client including the size and origin of the client, the number of employees working for the client, the client's organizational structure and the client's turnover in the country where the venture will be conducted and elsewhere.

The second subcategory within the client data category in this example, social and environmental practices (22B), may be used to describe the client's attitude toward social and environmental responsibility. Social and environmental practices data may be used to gain an understanding of the client's current practices with respect to social and environmental activities as well as the human resources the client applies to social and environmental responsibility.

The third subcategory within the client data category in this example, past practices (22C), may be used to gain an understanding of social and environmental projects implemented by the client in the past. The fourth subcategory within the client data category in this example, client expectations (22D), may be used to determine how the client wishes to participate in the social risk investment process in connection with the economic venture. In one embodiment, this data should indicate whether the client wishes to approve all aspects of the social risk management process, provide top-level approval only, be kept informed, and/or be consulted.

Referring to FIG. 2G, in one embodiment, the present invention provides one or more graphic user interfaces (21) to facilitate entry of client data into the system. In this example, the present invention provides data entry fields and/or drop down menus (19) for each aspect of the client data subcategory, i.e., client portrait, social and environmental practices, past practices, and client expectations. In one embodiment, the GUI of the present invention provides data entry fields and/or drop down menus for findings, project impact, and source information relating to each client data subcategory.

As noted above, background data utilized by the present invention may be broken down into community, project, client, and stakeholder data categories (18, 20, 22, and 24, respectively). In one embodiment, stakeholder data provides information regarding individuals and/or groups that can influence or be influenced by the venture. In one embodiment, stakeholder information may be used to identify stakeholders and generate output data relating to their influence relative to the venture.

Referring to FIG. 2H, in one embodiment, stakeholder data (24) may be utilized to generate a stakeholder analysis chart depicting the relative positions of stakeholders toward the venture as well as any informal networks between stakeholders. The stakeholder analysis chart may also be used to chart changes in stakeholder positions over time. In one embodiment the stakeholder chart utilizes the degree of influence of each stakeholder (24T) on the vertical axis (24V) and the degree of support or opposition (as the case may be) on the horizontal axis (24H). In one embodiment, dotted lines (24L) may be used to indicate informal networks between stakeholders (24T).

Referring to FIG. 21, in one embodiment, the present invention provides one or more graphic user interfaces (21) to facilitate entry of stakeholder data (24) into the system. This data may also be used to generate the stakeholder analysis chart described above. In this example, the present invention provides data entry fields and/or drop down menus (19) for each aspect of the stakeholder data category, i.e., degree of influence, degree of support, relevance coefficient (influence+support) and networking coefficient in this example. In one embodiment, the GUI of the present invention provides data entry fields and/or drop down menus for each stakeholder (24T), i.e., municipal government, potential employees, labor unions, farm owners, local entrepreneurs, and local rights groups in this example. The data can be used to rank the relative importance of each stakeholder (24T) using any suitable score and/or ranking system. This feature of the present invention ensures that the most influential stakeholders are identified so that they may be taken into account during the social risk management process.

Referring back to FIG. 1, background data relating to an economic venture may be collected and stored upon the database, as illustrated by Box (12). In one embodiment, background data may be analyzed in order to identify social hazards that may be encountered in connection with the venture, as illustrated by Boxes (26) and (28). In one embodiment, the analysis of background data includes a review of all community, project, client, and stakeholder data collected with respect to the venture. The analysis may include the identification and cross-referencing of related background data across multiple categories and/or subcategories in order to provide a complete picture of the social risk landscape.

In one embodiment, factors that may be considered during background data analysis may include whether one or more hazards are: likely to threaten an organization's license to operate, likely to result in direct financial costs to the venture, likely to result in strained relations with stakeholders, likely to undermine perceptions or the reputation of the organization, likely to disrupt the venture, likely to result in decreased returns to shareholders, and/or likely to result in non-compliance with relevant regulations or the internal policies of the organization.

Referring to FIGS. 1 and 4A, in one embodiment, the present invention provides a GUI (21) for displaying identified social hazards (30I), as illustrated by Box (30). In this example, the identified social hazards (30I) may be illustrated by the GUI (21) and information concerning each identified hazard may be provided adjacent thereto. In this example, the GUI (21) of the present invention displays information regarding whether the hazard is a pre-existing condition, whether the hazard was caused by the venture, the expected change in local context, the potential impact of the social hazard and the affected stakeholders. In one embodiment, the GUI (21) may allow the user to enter comments and/or amendments relevant to the identified social hazards via one or more dropdown menus or data entry fields (19).

In one embodiment, the present invention conducts a risk assessment of each identified social hazard and displays the results to the user, as illustrated by Boxes (32) and (34). In one embodiment, this entails a determination of the severity and likelihood of each identified hazard using background information available to the system.

In one embodiment, severity may be defined in terms of potential monetary loss to the venture should the hazard materialize. For example, a severity scoring system may be used such that a light severity indicator having a score of “−1” would be used or hazards having potential losses of less than $10,000, a serious severity indicator having a score of “−2” would be used for hazards having potential losses of less than $100,000, a major severity indicator having a score of “3” would be used for hazards having potential losses of less than $1,000,000, a catastrophic severity indicator having a score of “−4” would be used for hazards having potential losses of less than $10,000,000, and a multi-catastrophic severity indicator having a score of “−5” would be used for hazards having potential losses of more than $10,000,000.

In one embodiment, the likelihood of social hazards may be quantified using any suitable descriptors. In one embodiment, a likelihood scale may be used to describe the likelihood of identified social hazards. For example, a “very low” score of “1” may be applied to hazards that have not presented problems in the past, a low score of “2” may be applied to hazards that have impacted the organization fewer than one time per year, a medium score of “3” may be applied to hazards that have impacted the organization once or more per year, a high score of “4” may be applied to hazards that have impacted the organization once or more per month, and a very high score of “5” may be applied to hazards that have impacted the organization once or more per week.

Referring to FIG. 4B, in one embodiment, the present invention provides risk assessment output to the user upon a GUI (21). In one embodiment, risk assessment information is displayed utilizing a risk assessment score which constitutes the severity score multiplied by the likelihood score described in the example above. In this example, the risk assessment range would be between −1 to −25 and may be used to categorize the risk of each identified social hazard as insignificant (−1 to −2), low (−2 to −5), medium (−5 to −10), high (−10 to −20), or extreme (−20 to −25).

Risk assessment information may further be color coded to indicate the relative severity and likelihood of each hazard. For example, a black or red color may be used to indicate that a given hazard is of particular importance while a green or blue color may be used to indicate a relative lack of severity for a particular hazard. In one embodiment, the GUI (21) may allow the user to enter comments and/or amendments relevant to the assessed risk of each social hazard via one or more dropdown menus or data entry fields (19).

In one embodiment, the present invention identifies and displays one or more prevention or mitigation measures to address each identified social hazard, as illustrated by Boxes (36) and (38) of FIG. 1. In one embodiment, prevention measures are intended to reduce the likelihood that an issue will occur while mitigation measures are intended to reduce the impact of an issue on the venture. Such measures can be simple and low-cost, such as conducting awareness-raising sessions to train employees to close gates when driving in and out of farmers' fields, or introducing specialized training programs designed to help local unemployed workers find jobs. Measures can also be complex and expensive, such as building educational, medical or water filtration facilities in poor rural areas. FIG. 4C provides an example GUI (21) illustrating a range of prevention and mitigation measures identified by the system. In one embodiment, identified prevention and/or mitigation measures are displayed according to their relative importance to the economic venture.

In one embodiment, the present invention provides an updated risk assessment feature that assesses the social risk remaining assuming that the identified prevention/mitigation measures have been successfully implemented. This allows the user to review the updated risk assessment (also referred to herein as the residual risk) and prospectively consider whether any other measures should be taken. In one embodiment, the example GUI (21) of FIG. 4B may be utilized to present an updated risk assessment to the user. In one embodiment, after assuming the successful implementation of the identified prevention/mitigation measures, the residual risk level associated with each particular hazard should preferably have a risk level ranking (risk severity multiplied by risk likelihood in the example above) no higher than “low.” In one embodiment, social hazards having a risk level ranking greater than “low” should be revisited in order to reduce the accompanying risk.

In one embodiment, the present invention may conduct a feasibility review of the identified prevention/mitigation measures, as illustrated by Box (40) of FIG. 1. In one embodiment, this may be accomplished by considering the estimated cost to implement the measure(s), the complexity associated with implementation, and any potential unintended consequences that might result from implementation. FIG. 4D provides an example GUI (21) illustrating a feasibility assessment for each prevention and mitigation measure identified by the system. In one embodiment, the feasibility assessment may be displayed to the user, as illustrated by Box (42) of FIG. 1. In one embodiment, the user may enter comments and/or amendments relevant to the feasibility of each measure via one or more dropdown menus or data entry fields (19) provided by the GUI (21).

In one embodiment, the present invention utilizes information available to the system, including background data and user input/comments, to generate a social risk management outline, as illustrated by Box (44) of FIG. 1. In one embodiment, the management outline provides an overview of how each identified social risk is to be handled for the economic venture. FIG. 4E provides an example social risk management outline illustrated upon a GUI (21). In one embodiment, the social risk management outline provides a listing of the work (44W) expected to lead to one or more social hazards (44H), the stakeholders expected to be affected by the social hazard(s) (44A), the risk assessment (44I) including likelihood, severity, and risk level scores, the suggested control/mitigation measures (44M), and the expected residual risk (44R). In one embodiment, the user may enter comments and/or amendments to the social risk management plan via one or more dropdown menus or data entry fields (19) provided by the GUI (21).

In one embodiment, the social risk management outline may include a ramp down strategy for each proposed activity. The ramp down strategy may include guidance and/or suggestions regarding the closure and handover of social risk management efforts in the community. This feature of the present invention helps ensure that social risk management initiatives are removed and/or ramped-down in a manner which avoids disruption to the community.

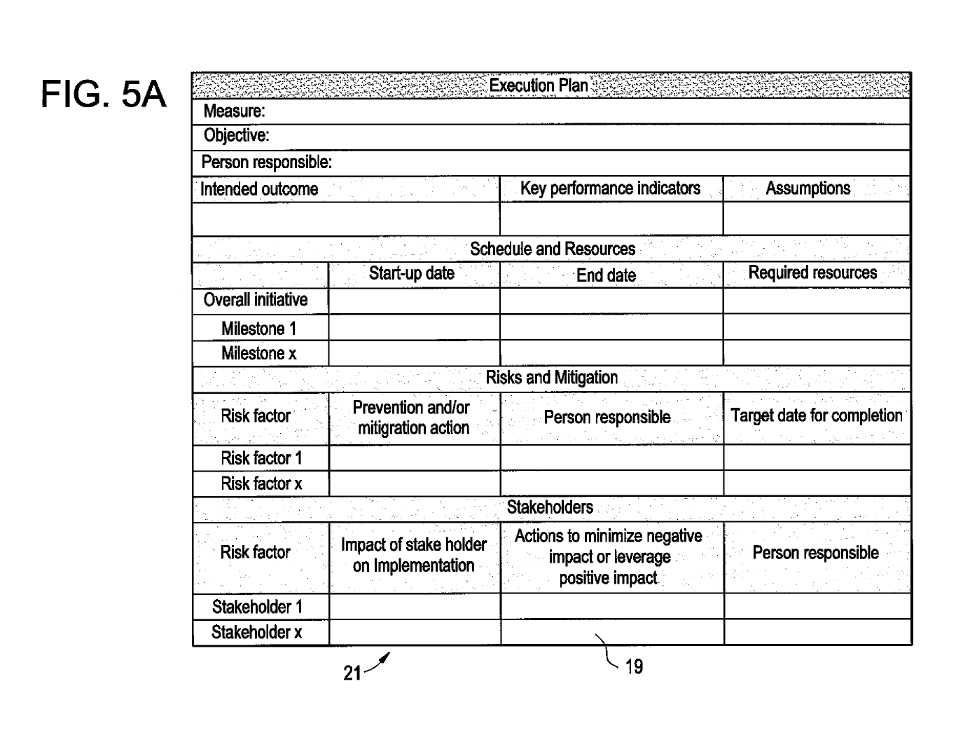

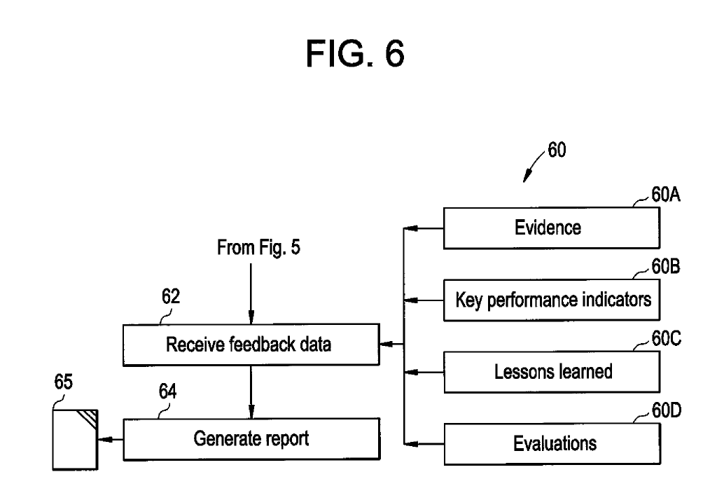

Referring to FIG. 5, in one embodiment, the present invention provides a reality check feature wherein each of the proposed prevention/mitigation measures are subjected to a series of standards to ensure that they: (1) address project needs and (2) are generally aligned with organization's policies and standards, as illustrated by Box (46). This process may include applying standards such as whether: (1) the proposed measure(s) align with organizational policies and standards; (2) whether the proposed measure(s) align with the roles and responsibilities of organization with respect to its contract with the client; (3) whether the client has any objections to the proposed measure(s); (4) whether the proposed measure(s) will assist in decreasing social needs and problems identified within the community; (5) whether the proposed measure(s) benefit (or threaten) the most disadvantaged people within the community; (6) whether the proposed measure(s) encourage self-reliance rather than dependence; and (7) whether the proposed measure(s) will result in social, economic and environmental benefits. If the proposed measures do not pass one or more aspects of the reality check, they may be modified, as illustrated by Boxes (48) and (50) of FIG. 5.

In one embodiment, the present invention generates an execution plan for each of the proposed measures, as illustrated by Box (52) of FIG. 5. In one embodiment, each execution plan provides specific objectives related to the implementation of each prevention/mitigation measure. FIG. 5A provides an example execution plan illustrated upon a GUI (21). In one embodiment, the execution plan provides a schedule showing milestones, budget information, risk assessment(s), and Key Performance Indicators (KPIs) for monitoring progress. In one embodiment, the user may enter comments and/or amendments to the execution plan via one or more dropdown menus or data entry fields (19) provided by the GUI (21).

In one embodiment, the present invention may address how decisions are made and approved with respect to the social risk management process. In one embodiment, the present invention is capable of providing recommendations with respect to whom (both inside and outside the organization) should be tasked with implementing and overseeing proposed prevention/mitigation measures, as illustrated by Box (54) of FIG. 5. Suggested personnel may include individual managers (56), steering committees (58), or any other suitable group of individuals. In one embodiment, the present invention uses background data concerning various aspects of the venture along with data gleaned from personnel files to arrive at suggestions regarding who should be assigned to the social risk management of the venture.

In one embodiment, the social risk management process of the present invention provides a monitoring and evaluation feature designed to assess the effectiveness of prevention/mitigation measures and generate recommendations for future improvement. In one embodiment, significant investments in social risk management measures may require the application of objective evaluations in order to ensure beneficial results. Such evaluations may also provide external review to provide impartial analysis for third parties such as authorities and/or community groups. In one embodiment, the present invention utilizes various forms of feedback data to generate a comprehensive evaluation report.

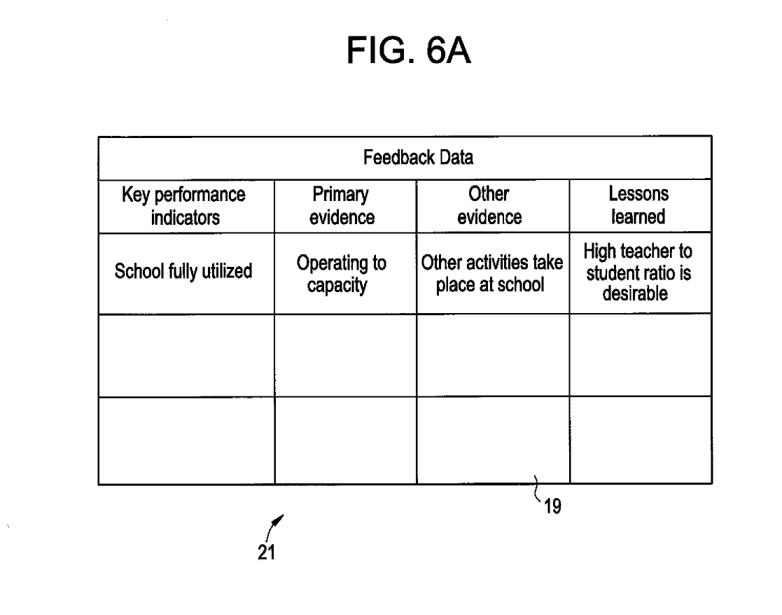

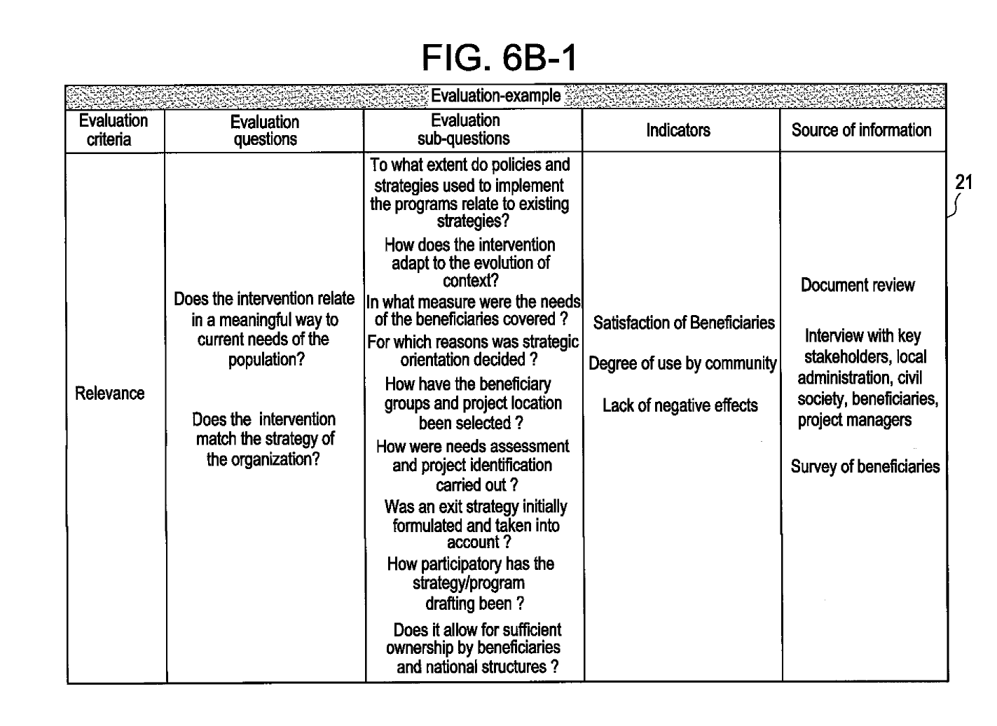

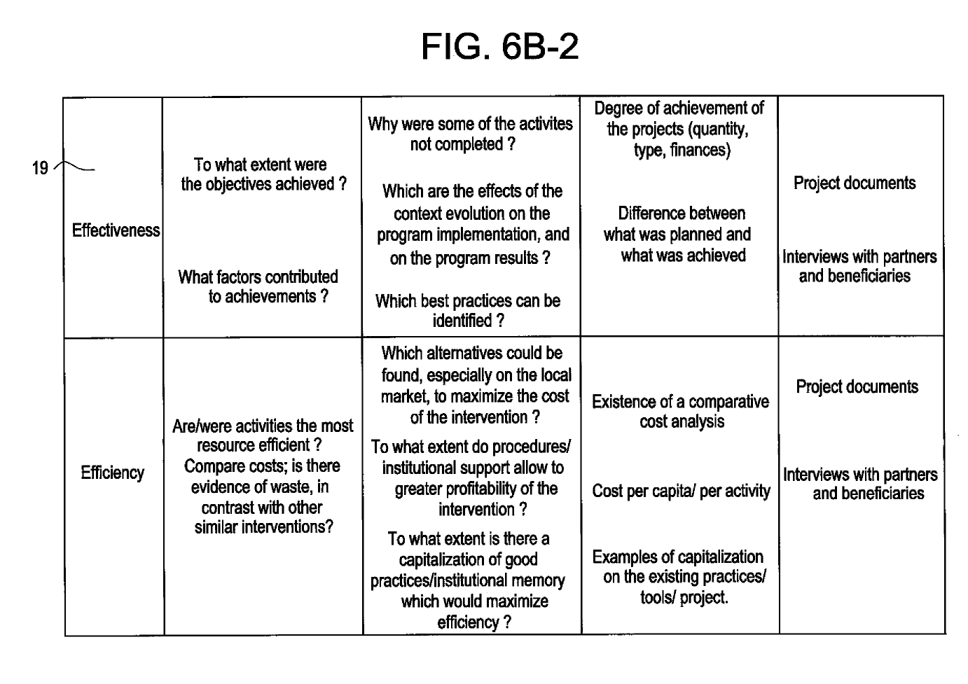

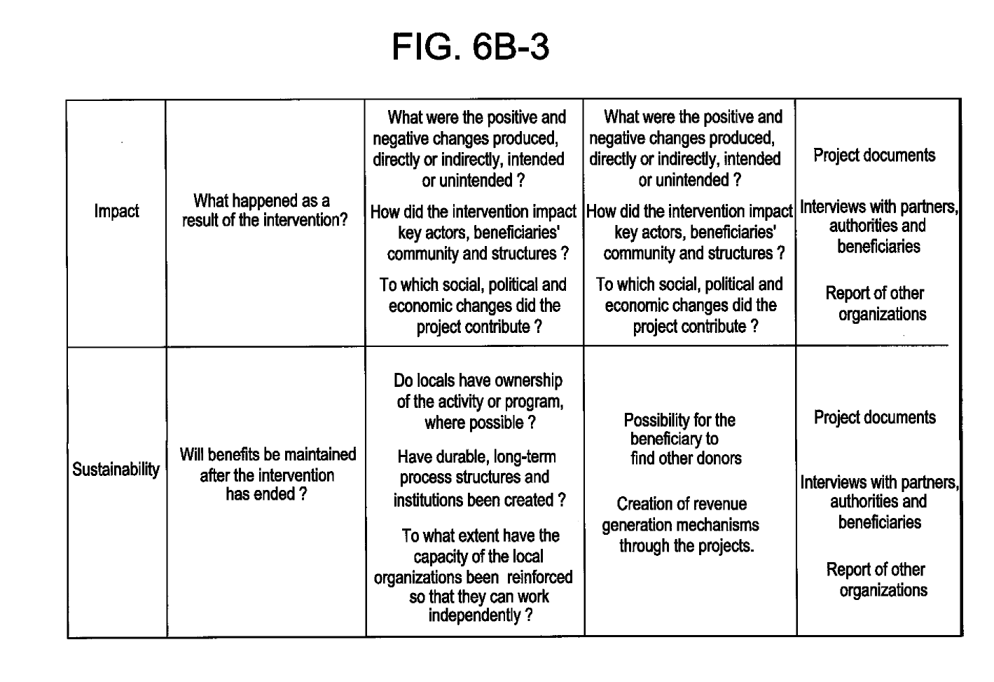

In one embodiment, the present invention is capable of receiving and storing feedback data (60) with respect to each implemented prevention/mitigation measure, as illustrated by Box (62) of FIG. 6. FIG. 6A provides an example GUI (21) though which feedback data may be captured. In one embodiment, feedback data may include evidence (60A) pertaining to the results generated by the measure(s), applicable KPIs (60B), and/or lessons learned data (60C). For example, KPIs could include the number of teachers and students in relation to optimal capacity, budget management, staffing and training plans, frequency of parent-teacher meetings, condition of facilities and equipment, and general learning atmosphere. In one embodiment, the user may enter feedback data via one or more dropdown menus or data entry fields (19) provided by the GUI (21).

In one embodiment, the present invention provides a unique GUI (21) for receiving feedback data in the form of evaluations (60D), as illustrated in FIG. 6B. In this example, relevance, effectiveness, efficiency, impact, and sustainability data entry fields (19) are provided along with specific evaluation questions relating thereto. In one embodiment, indicators and information sources relating to each evaluation criteria are also provided by the GUI (21).

In one embodiment, the present invention utilizes feedback data to generate one or more evaluation reports (65) illustrating the success, or lack thereof, of the implemented prevention/mitigation measures, as illustrated by Box (64). Evaluation reports generated by the present invention may be disseminated electronically and/or otherwise provided to appropriate audiences, in whole or in part, including organization staff, clients, local authorities and/or community representatives. In one embodiment, the present invention allows evaluation reports to be generated in various forms. In one embodiment, the present invention generates full copies of the evaluation report as well as summary sheets. This allows the user (or applicable managers) to distinguish which version of the report should be given to whom. For example, it may be desirable to provided full copies of the evaluation report to organization personnel but only report summaries to others outside the organization.

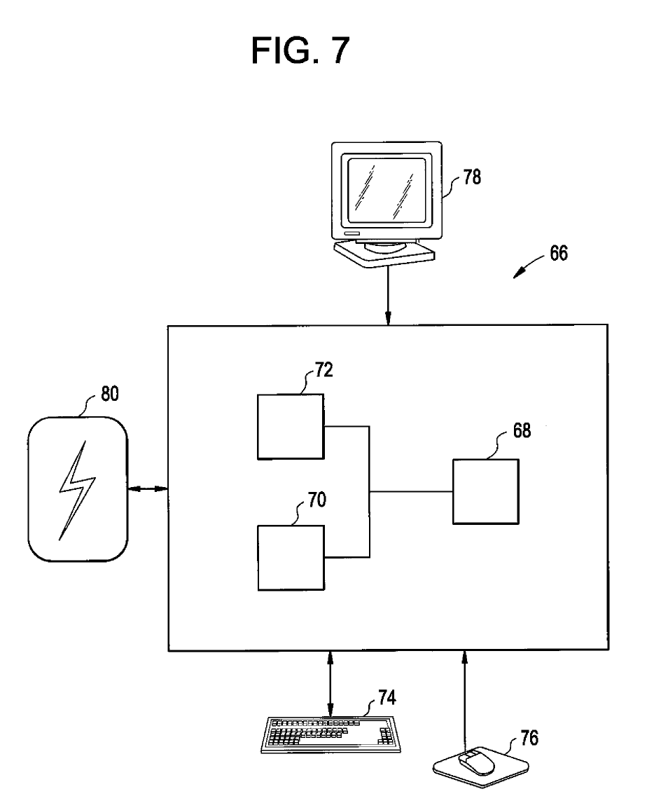

The present invention may be implemented on virtually any type of computer regardless of the platform being used. Referring to FIG. 7, a computer system (66) includes a processor (68), associated memory (70), a storage device (72), and numerous other elements and functionalities typical of modern computers (not shown). The computer (66) may also include input devices, such as a keyboard (74) and a mouse (76), and output devices, such as a display monitor (78). The computer system (66) may be connected to a local area network (LAN) or a wide area network (e.g., the Internet) (80) via a network interface connection (not shown). Those skilled in the art will appreciate that these input and output devices may take other forms, now known or later developed. Further, those skilled in the art will appreciate that one or more elements of the aforementioned computer system (66) may be located at a remote location and connected to the other elements over a network.

The invention may be implemented on a distributed system having a plurality of individual computer systems, where each portion of the invention may be located on a different system within the distributed system. The present invention may also be implemented upon a hand-held or other portable computing device. Further, software instructions to perform embodiments of the invention may be stored on a computer readable medium such as a compact disc (CD), DVD, diskette, tape, file, hard drive, or any other suitable computer readable storage device.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

1. A computer implemented method of facilitating social risk management comprising:
a computer processor operative to receive and store background data relating to an economic venture, wherein said background data comprises community, project, client, and stakeholder information relating to one or more aspects of said venture, wherein said community information further comprises geographic information, demographic information, and economic information;
utilizing said background data, identify one or more social risk hazards associated with said venture;
identify prevention or mitigation measures applicable to one or more of said social risk hazards; and
display said identified prevention or mitigation measures upon a graphic user interface.

2. The computer implemented method of claim 1, wherein the processor is operative to:
assess the severity or likelihood of said identified social risk hazards and displaying said identified social risk hazards upon said graphic user interface in order of severity or likelihood.

3. (canceled)

4. The computer implemented method of claim 1, wherein said project information further comprises project scope information, contract information, and responsibilities information.

5. The computer implemented method of claim 1, wherein said client information further comprises client portrait information, social and environmental practices information, past practices information, and client expectations information.

6. The computer implemented method of claim 1, wherein the processor is operative to:
generate a feasibility assessment for said identified prevention or mitigation measures; and
display said feasibility assessment upon said graphic user interface.

7. The computer implemented method of claim 1, wherein the processor is operative to:
receive feedback information relating to the implementation of said prevention or mitigation measures;
analyze the effectiveness of said implementation of said prevention or mitigation measures; and
generate an evaluation report.

8. A non-transitory computer-readable storage medium for facilitating social risk management comprising instructions which, when executed, cause a computing device to:
receive and store background data relating to an economic venture, wherein said background data comprises community, project, client, and stakeholder information relating to one or more aspects of said venture, wherein said community information further comprises geographic information, demographic information, and economic information;
identify one or more social risk hazards associated with said venture utilizing said background data;
identify prevention or mitigation measures applicable to one or more of said identified social risk hazards; and
display said identified prevention or mitigation measures upon a graphic user interface.

9. The computer-readable storage medium of claim 8, wherein the instructions, when executed, cause the computing device to:
assess the severity or likelihood of said identified social risk hazards and display said identified social risk hazards upon said graphic user interface in order of severity or likelihood.

10. (canceled)

11. The computer-readable storage medium of claim 8, wherein said project information further comprises project scope information, contract information, and responsibilities information.

12. The computer-readable storage medium of claim 8, wherein said client information further comprises client portrait information, social and environmental practices information, past practices information, and client expectations information.

13. The computer-readable storage medium of claim 8, wherein the instructions, when executed, cause the computing device to:
generate a feasibility assessment for said identified prevention or mitigation measures; and
display said feasibility assessment upon said graphic user interface.

14. The computer-readable storage medium of claim 8, wherein the instructions, when executed, cause the computing device to:
receive feedback information relating to the implementation of said prevention or mitigation measures;
analyze the effectiveness of said implementation of said prevention or mitigation measures; and
generate an evaluation report.

15. A social risk management system comprising:
a processor operative to receive and store background data relating to an economic venture, wherein said background data comprises community, project, client, and stakeholder information relating to one or more aspects of said venture, wherein said community information further comprises geographic information, demographic information, and economic information;
identify one or more social risk hazards associated with said venture utilizing said background data;
identify prevention or mitigation measures applicable to one or more of said identified social risk hazards; and
display said identified prevention or mitigation measures upon a graphic user interface.

16. The social risk management system of claim 15, wherein the processor is operative to:
assess the severity or likelihood of said identified social risk hazards and display said identified social risk hazards upon said graphic user interface in order of severity or likelihood.

17. (canceled)

18. The social risk management system of claim 15, wherein said project information further comprises project scope information, contract information, and responsibilities information.

19. The social risk management system of claim 15, wherein said client information further comprises client portrait information, social and environmental practices information, past practices information, and client expectations information.

20. The social risk management system of claim 15, wherein the processor is operative to:
generate a feasibility assessment for said identified prevention or mitigation measures; and
display said feasibility assessment upon said graphic user interface.

21. The social risk management system of claim 15, wherein the processor is operative to:
receive feedback information relating to the implementation of said prevention or mitigation measures;
analyze the effectiveness of said implementation of said prevention or mitigation measures; and
generate an evaluation report.
